(19) United States
(12) Patent Application Publication
(10) Pub. No.: US 2016/0380549 A1
(43) Pub. Date: Dec. 29, 2016

(54) AC-AC POWER SOURCE CONVERSION DEVICE AND CONVERSION METHOD THEREOF

(71) Applicant: HEP TECH CO., LTD., Taichung City (TW)

(72) Inventors: CHING-TSAI PAN, Hsinchu City (TW); PO-YEN CHEN, Taipei City (TW); TA-SHENG HUNG, Taichung City (TW)

(21) Appl. No.: 15/039,500

(22) PCT Filed: Oct. 14, 2014
(86) PCT No.: PCT/CN2014/000906

§ 371 Date: May 26, 2016

(30) Foreign Application Priority Data
Nov. 29, 2013 (CN) 201310636703.9

(51) Int. Cl. H02M 5/458; H02M 3/07

(52) U.S. Cl. CPC H02M 5/458; H02M 3/07; H02M 2001/007

(57) ABSTRACT

An AC-AC power source conversion device, comprising a rectifier circuit (10), an active power factor correction circuit (20), an automatic charge pumping circuit (30) and an inverter circuit (40), wherein the rectifier circuit is connected to an AC power source (100), receives the electric energy therefrom, and then converts the same into the DC electric energy for output; the active power factor correction circuit is connected to the rectifier circuit, receives the electric energy therefrom, and outputs the same after promoting a power factor; the automatic charging pumping circuit is connected to the active power factor correction circuit, receives the electric energy therefrom, and then adjusts and outputs same; and the inverter circuit is connected to the automatic charge pumping circuit and a load (200), receives the electric energy therefrom, converts same into the AC electric energy, and then outputs same to the load.

### TECHNICAL FIELD

The present disclosure relates to power conversion, in particular to an AC-AC power source conversion device and the conversion method thereof.

### BACKGROUND

A conventional AC-AC power conversion device usually has a rectifier circuit, an output capacitor and an inverter so as to convert an AC power source into a DC power source; the output capacitor is connected to the output side of the rectifier circuit in parallel; the inverter is connected to the output capacitor, and then connected to a load.

When the AC-AC power conversion device is in operation, the phase of the output voltage of the AC power source tends to be different from the phase of the input current of the AC power source, which will result in low power factor and serious total harmonic distortion. In addition, the rectifier circuit will not charge the output capacitor unless the output voltage of the DC electric energy outputted from the rectifier circuit is higher than the voltage of the output capacitor; accordingly, the charging time of the output capacitor will be reduced, and the on time of the diode in the rectifier circuit will also be reduced to further increase the peak value of the turn-on current, which will not only distort the waveform of the input current and reduce the power factor, but also will further influence the current response speed of the inverter; for the reason, the AC electric energy outputted to the load will be seriously distorted.

Therefore, the above conventional AC-AC power source conversion device still has a lot of shortcomings and defects in structure and use needed to be further improved. In order to solve the above problems, a lot of circuit designers have kept trying hard to find a solution, but a proper solution has yet to be successfully developed until now; besides, the currently available products have no proper structure to solve the above problems; thus, how to create a novel AC-AC power source conversion device and the conversion method thereof not only have become an important R&D object, but also have become the most important problem to be solved in the world.

### SUMMARY

In view of above, the object of the present invention is to provide an AC-AC power source conversion device and the conversion method thereof to overcome the shortcomings of the currently available AC-AC power source conversion devices; the technical problems solved by the present invention are not only to achieve high power factor, but also achieve swift response and low-ripple output voltage.

The object of the present invention can be realized by adopting the following technical schemes. The present invention provides an AC-AC power source conversion device for converting the electric energy of an AC power source and then supply the electric energy to a load; the AC-AC power source conversion device includes a rectifier circuit, an active power factor correction circuit, an automatic charge pumping circuit and an inverter circuit. More specifically, the input side of the rectifier circuit is connected to the AC power source for receiving the electric energy of the AC power source, converting the electric energy into the DC electric energy, and outputting the DC electric energy from the output side of the rectifier circuit; besides, the output side has a positive terminal and a negative terminal. The active power factor correction circuit is connected to the output side of the rectifier circuit for receiving the DC electric energy of the rectifier circuit, increasing the power factor of the DC electric energy and outputting the DC electric energy; the active power factor correction circuit includes a first diode, where the cathode of the first diode is connected to the positive terminal; a first capacitor, where one end of the first capacitor is connected to the anode of the first diode; an electronic switch, where one end of the electric switch is connected to the other end of the first capacitor, and the other end of the electronic switch being connected to the negative terminal; a first inductor, where one end of the first inductor is connected to the junction of the cathode of the first diode and the positive terminal, and the other end of the first inductor is connected to the junction of the first capacitor and the electronic switch; a second diode, where the anode of the second diode is connected to the junction of the electronic switch and the negative terminal; a second inductor, where one end of the second inductor is connected to the junction of the anode of the first diode and the first capacitor, and the other end of the second inductor is connected to the cathode of the second diode. The automatic charge pumping circuit is connected to the active power factor correction circuit for receiving the DC electric energy outputted from the active power factor correction circuit, adjusting the DC electric energy and outputting the DC electric energy; the automatic charge pumping circuit includes a third diode, where the anode of the third diode is electrically connected to the junction of the cathode of the second diode and the second inductor, and the cathode of the third diode is electrically connected to the junction of the second inductor, the anode of the first diode and the first capacitor; a second capacitor, where one end of the second capacitor is connected to the cathode of the third diode; a third inductor, where one end of the third inductor is connected to the other end of the first capacitor, and the other end of the third inductor is electrically connected to the junction of the cathode of the third diode and the second capacitor; an equivalent capacitor, where one end of the equivalent capacitor is connected to the junction of the second capacitor and the third inductor, and the other end of the equivalent capacitor is connected to the junction of the anode of the third diode, the cathode of the second diode and the second inductor; the inverter circuit is electrically connected to the equivalent capacitor of the automatic charge pumping circuit, and connected to the load for receiving the DC electric energy outputted from the automatic charge pumping circuit, and converting the DC electric energy into an AC electric energy with a predetermined frequency, and then outputting the AC electric energy with the predetermined frequency to the load.

The object of the present invention can be further realized by adopting the following technical measures.

Regarding the aforementioned AC-AC power source conversion device, the equivalent capacitor is composed of a third capacitor and a fourth capacitor, and the third capacitor is connected to one end of the fourth capacitor; the inverter circuit includes a first switch and a second switch, and the first switch is connected to one end of the second switch; besides, the third capacitor and the other end of the first switch are connected to the junction of the second capacitor and the third inductor, and the fourth capacitor and the other end of the second switch are connected to the junction of the anode of the third diode, the cathode of the second diode and the second inductor; moreover, one end of the load is connected to the junction of the third capacitor and the fourth capacitor, and the other end of the load is connected to the junction of the first switch and the second switch.

Regarding the aforementioned AC-AC power source conversion device, the inverter circuit includes a first switch, a second switch, a third switch and a fourth switch; the first switch is connected to one end of the third switch, and the second switch is connected to one end of the fourth switch; besides, the other end of the first switch and the other end of the second switch are connected to the junction of the equivalent capacitor, the second capacitor and the third inductor, and the other end of the third switch and the other end of the fourth switch are connected to the junction of the equivalent capacitor, the anode of the third diode, the cathode of the second diode and the second inductor; moreover, one end of the load is connected to the junction of the first switch and the third switch, and the other end of the load is connected to the junction of the second switch and the fourth switch.

Regarding the aforementioned AC-AC power source conversion device, the automatic charge pumping circuit further includes a fourth diode; one end of the fourth diode is connected to the junction of the cathode of the third diode and the second capacitor, and the other end of the fourth diode is connected to the third inductor, whereby the third inductor is electrically connected to the junction of the cathode of the third diode and the second capacitor via the fourth diode.

Regarding the aforementioned AC-AC power source conversion device, the anode of the fourth diode is connected to the junction of the cathode of the third diode and the second capacitor, and the cathode of the fourth diode is connected to the third inductor.

Regarding the aforementioned AC-AC power source conversion device, the automatic charge pumping circuit further includes a fifth diode; one end of the fifth diode is connected to the junction of the second inductor, the anode of the first diode and the first capacitor, and the other end of the fifth diode is connected to the junction of the cathode of the third diode and the second capacitor, whereby the cathode of the third diode and the second capacitor are electrically connected to the junction of the second inductor, the anode of the first diode and the first capacitor via the fifth diode.

Regarding the aforementioned AC-AC power source conversion device, the anode of the fifth diode is connected to the junction of the second inductor, the anode of the first diode and the first capacitor, and the cathode of the fifth diode is connected to the junction of the cathode of the third diode and the second capacitor.

The object of the present invention can be further realized by adopting the following technical schemes. According to the above design, the conversion method of the AC-AC power source conversion device includes the following steps:

A. turning on the electronic switch to charge the first inductor by the DC electric energy outputted from the rectifier circuit, and charging the second inductor by the first capacitor, and charging the equivalent capacitor by the second capacitor and the third inductor to make the equivalent capacitor power the load via the inverter circuit;

B. turning off the electronic switch to stop the DC electric energy outputted from the rectifier circuit to charge the first capacitor by the first inductor, and change the third inductor, the second capacitor and the equivalent capacitor by the second inductor to make the equivalent capacitor keep powering the load via the inverter circuit;

C. stopping the second inductor from charging the third inductor, the second capacitor and the equivalent capacitor to turn off the third diode, and make the third inductor charge the second capacitor so as to reverse the voltage across the second capacitor and make the equivalent capacitor keep powering the load via the inverter circuit;

D. turning on the third diode to reverse the voltage across the second capacitor and the voltage across the third inductor, and charging the equivalent capacitor to make the equivalent capacitor keep powering the load via the inverter circuit.

The object of the present invention can be further realized by adopting the following technical measures.

Regarding the aforementioned conversion method, wherein the method further includes a step after the step D, and the step is to repeat executing the step A to the step D.

Regarding the aforementioned conversion method, wherein after the step B, the first inductor stops charging the first capacitor to turn off the first diode.

Regarding the aforementioned conversion method, wherein during the step B, the second inductor charges the equivalent capacitor via the resonant circuit formed by the second capacitor and the third inductor.

Regarding the aforementioned conversion method, wherein after the second capacitor and the third inductor form the resonant circuit in the step C, the third inductor charges the second capacitor to reverse the polarity of the voltage across the second capacitor; then, when the voltage across the third inductor is higher than the voltage across the equivalent capacitor, the third diode is turned on, and then the method proceeds to the step D.

Compared with prior art, the present invention has obvious advantages and beneficial effects. By means of the above technical schemes, the AC-AC power source conversion device and the conversion method thereof in accordance with the present invention have at least the following advantages and beneficial effects: via the above design, the present invention can not only increase the power factor during the power conversion, but also can achieve swift response and low-ripple output voltage.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a circuit diagram of a preferred embodiment of an AC-AC power source conversion device in accordance with the present invention;

FIG. 2A, FIG. 2B, FIG. 3A, FIG. 3B, FIG. 4A, FIG. 4B, FIG. 5A, FIG. 5B are the equivalent circuit diagram of the steps;

FIG. 6 is a circuit diagram of another preferred embodiment of an AC-AC power source conversion device in accordance with the present invention.

### DETAILED DESCRIPTION

The technical content of the present invention will become apparent by the detailed description of the following embodiments and the illustration of related drawings as follows.

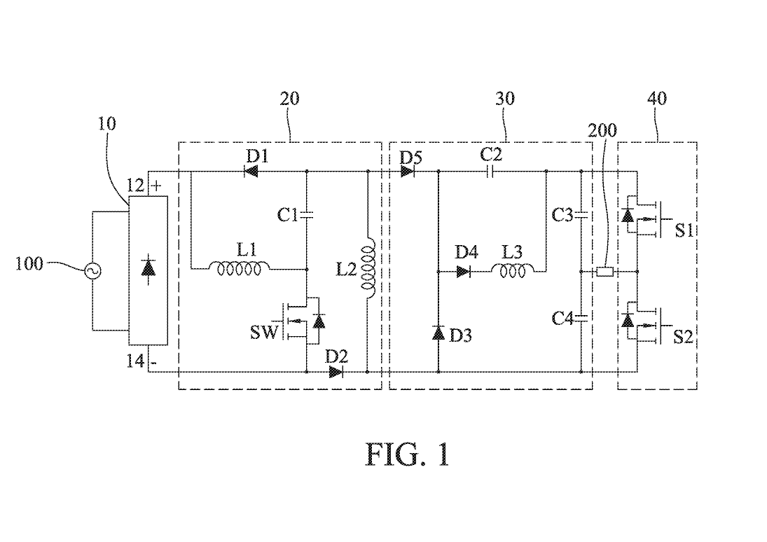

Please refer to FIG. 1, which is a preferred embodiment of an AC-AC power source conversion device in accordance with the present invention; the AC-AC power source conversion device can convert the electric energy of an AC power source 100 and then supply the electric energy to a load 200. The AC-AC power source conversion device includes a rectifier circuit 10, an active power factor correction circuit 20, an automatic charge pumping circuit 30 and an inverter circuit 40, wherein:

In the embodiment, the rectifier circuit 10 is a bridge rectifier, and its input side is connected to the AC power source 100 for receiving the electric energy of the AC power source 100, converting the electric energy into the DC electric energy, and outputting the DC electric energy from its output side; besides, its output side has a positive terminal 12 and a negative terminal 14 according to the polarity of the DC electricity energy outputted.

The active power factor correction circuit 20 is connected to the output side of the rectifier circuit 10 for receiving the DC electric energy of the rectifier circuit 10, increasing the power factor of the DC electric energy and then outputting the DC electric energy; the active power factor correction circuit includes 2 diodes (the first diode D1 and the second diode D2), a capacitor (the first capacitor C1), 2 inductors (the first inductor L1 and the second inductor L2) and an electronic switch SW. The connection relations of the above components are as follows:

The cathode of the first diode D1 is connected to the positive terminal 12.

One end of the first capacitor C1 is connected to the anode of the first diode D1.

One end of the electric switch SW is connected to the other end of the first capacitor C1, and the other end thereof is connected to the negative terminal 14.

One end of the first inductor L1 is connected to the junction of the cathode of the first diode D1 and the positive terminal 12, and the other end of the first inductor L1 is connected to the junction of the first capacitor C1 and the electronic switch SW.

The anode of the second diode D2 is connected to the junction of the electronic switch SW and the negative terminal 14.

One end of the second inductor L2 is connected to the junction of the anode of the first diode D1 and the first capacitor C1, and the other end thereof is connected to the cathode of the second diode D2.

The automatic charge pumping circuit 30 is connected to the active power factor correction circuit 20 for receiving the DC electric energy outputted from the active power factor correction circuit 20, adjusting the DC electric energy and outputting the DC electric energy, which includes 3 diodes (the third diode D3, the fourth diode D4 and the fifth diode D5), 3 capacitors (the second capacitor C2, the third capacitor C3 and the fourth capacitor C4) and an inductor (the third inductor L3). The connection relations of the above components are as follows:

The anode of the fifth diode D5 is connected to the junction of the second inductor L2, the anode of the first diode D1 and the first capacitor C1.

The anode of the third diode D3 is electrically connected to the junction of the cathode of the second diode D2 and the second inductor L2, and its cathode is electrically connected to the cathode of the fifth diode D5 so as to be electrically connected to the junction of the anode of the first diode D1, the second inductor L2 and the first capacitor C1 via the fifth diode D5.

The anode of the fourth diode D4 is connected to the junction of the cathode of the third diode D3, the cathode of the fifth diode D5 and the second capacitor C2.

One end of the third inductor D3 is connected to the other end of the first capacitor C1, and the other end thereof is connected to the cathode of the fourth diode D4 so as to be electrically connected to the junction of the cathode of the third diode D3, the cathode of the fifth diode D5 and the second capacitor C2.

The third capacitor C3 is connected to one end of the fourth capacitor C4, and the other end of the third capacitor C3 is connected to the junction of the second capacitor C2 and the third inductor L3; the other end of the fourth capacitor C4 is connected to the junction of the anode of the third diode D3, the cathode of the second diode D2 and the second inductor L2.

The inverter circuit 40 is electrically connected to the automatic charge pumping circuit 30, and connected to the load 200 for receiving the DC electric energy outputted from the automatic charge pumping circuit 30, and converting the DC electric energy into the AC electric energy with a predetermined frequency, and then outputting the AC electric energy with the predetermined frequency to the load 200. In the embodiment, the inverter circuit 40 is of half-bridge structure and includes a first switch S1 and a second switch S2, and the first switch S1 is connected to one end of the second switch S2; besides, the other end of the first switch S1 is connected to the junction of the second capacitor C2 and the third capacitor C3 and the third inductor L3, and the other end of the second switch S2 is connected to the junction of the fourth capacitor C4, the anode of the third diode D3, the cathode of the second diode D2 and the second inductor L2. In the embodiment, the specifications of the capacitors C1˜C4, the inductors L1˜L3, the input voltage, the electronic switch SW. the switching frequency of the switches S1, S2 and the load 200 are as shown in the following table:

| | | |
|---|---|---|
| First inductor L1 | 300 | μH |
| Second inductor L2 | 300 | μH |
| Third inductor L3 | 1000 | mH |
| First capacitor C1 | 200 | μF |
| Second capacitor C2 | 8 | nF |
| Third capacitor C3 | 100 | μF |
| Fourth capacitor C4 | 100 | μF |
| Input voltage Vin | 200 | Vrms |
| Switching frequency of electronic switch SW | 100 | KHz |
| Switching frequency of switches S1, S2 | 200 | Hz |
| Load resistance | 100 | Ω |

By means of the above structure design and specification, one end of the load 200 can be connected to the junction of the third capacitor C3 and the fourth capacitor C4, and the other end of the load 200 can be connected to the junction of the first switch S2 and the second switch S2; then, the above structure can not only increase the power factor, but also can achieve swift response and low-ripple output voltage by using the following conversion method; the method includes the following steps:

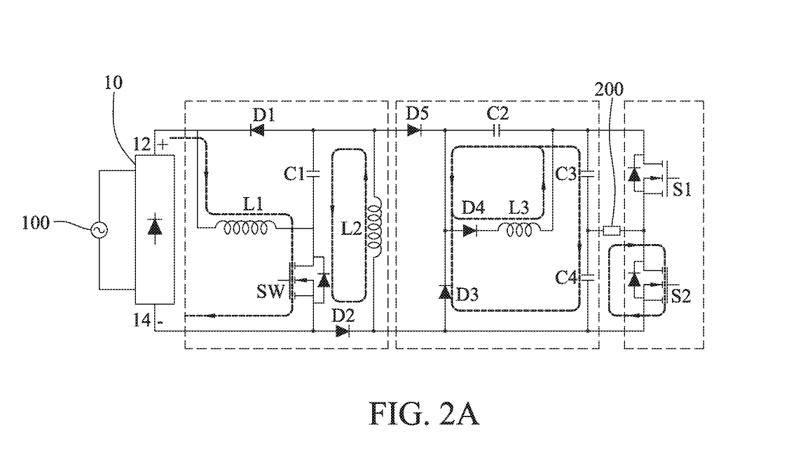

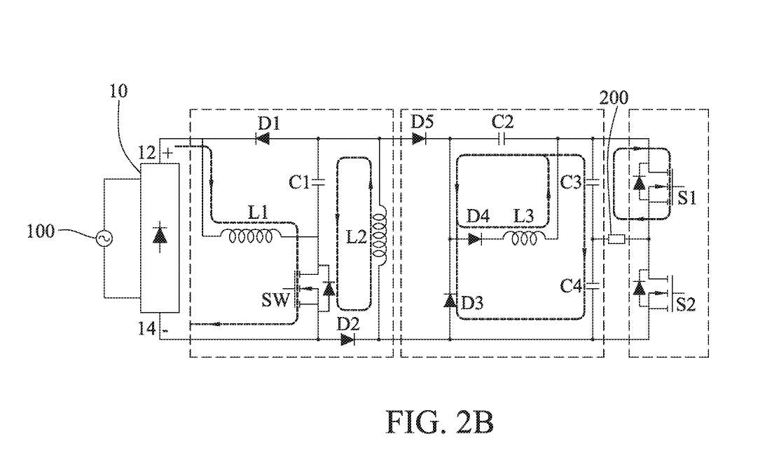

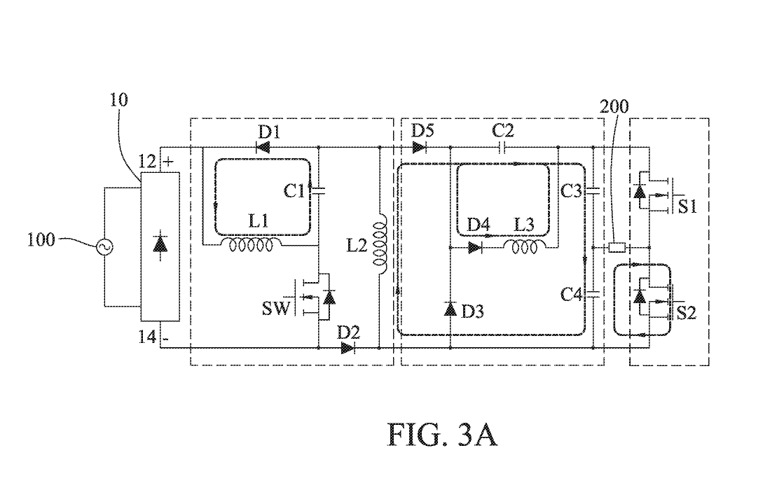

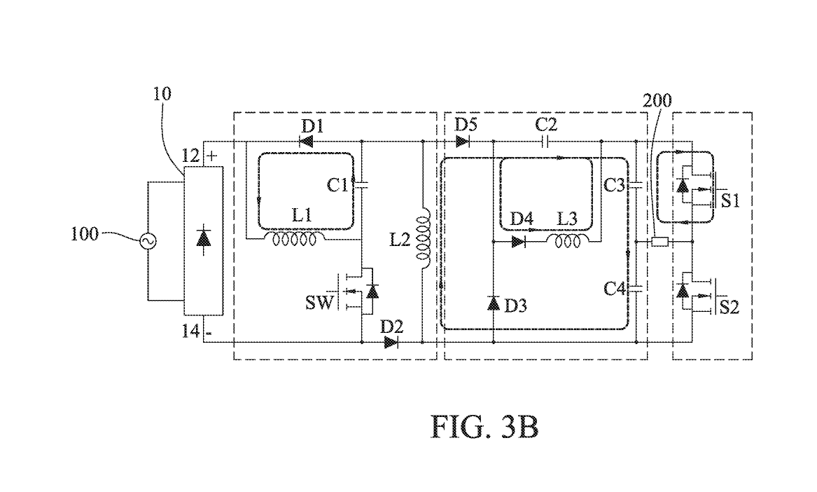

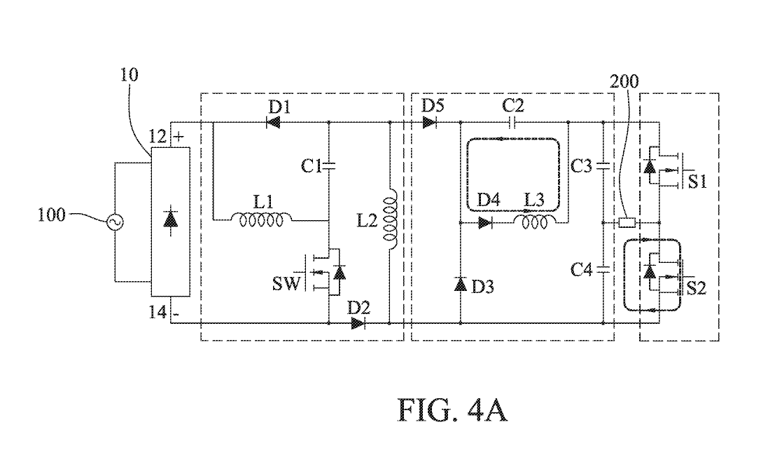

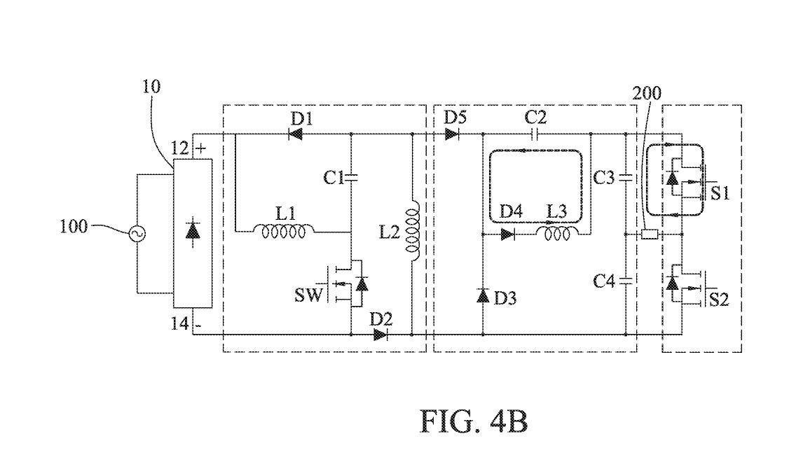

A. please refer to FIG. 2A and FIG. 2B, turning on the electronic switch SW to charge the first inductor L1 by the DC electric energy outputted from the rectifier circuit 10, and charging the second inductor L2 by the first capacitor C1, and charging the third capacitor C3 and the fourth capacitor C4 by the second capacitor C2 and the third inductor L3 to make the third capacitor C3 and the fourth capacitor C4 power the load via the inverter circuit 40. In addition, if the operation of the AC-AC power source conversion device is during the positive alternation status, the second switch S2 is turned on; in the meanwhile, the fourth capacitor C4 powers the load 200; the equivalent circuit is as shown in FIG. 2A. If the operation of the AC-AC power source conversion device is during the negative alternation status, the first switch S1 is turned on; in the meanwhile, the third capacitor C3 powers the load 200; the equivalent circuit is as shown in FIG. 2B.

B. please refer to FIG. 3A and FIG. 3B, turning off the electronic switch SW to stop the DC electric energy outputted from the rectifier circuit 10 to charge the first capacitor C1 by the first inductor L1, and make the second inductor L2 change the third inductor L3 and the second capacitor C2; then, making the second inductor L2 charge the third capacitor C3 and the fourth capacitor C4 via the resonant circuit formed by the second capacitor C2 and the third inductor L3 so as to make the third capacitor C3 and the fourth capacitor C4 keep powering the load 200 via the inverter circuit 40 according to the positive alternation status or the negative alternation status.

C. please refer to FIG. 4A and FIG. 4B, after the first inductor L1 stops outputting electricity energy, the first diode D1 is turned off; after the second inductor stops outputting electric energy, the fifth diode D5 is turned off. Meanwhile, the second capacitor C2 and the third inductor L3 form a resonant circuit to make the third inductor L3 charge the second capacitor C2 so as to reverse the polarity of the voltage across the second capacitor C2, and make the third capacitor C3 and the fourth capacitor C4 keep powering the load 200 via the inverter circuit 40 according to the positive alternation status or the negative alternation status.

D. when the voltage across the third inductor C3 is higher than the total voltage across the third capacitor C3 and the fourth capacitor C4, the third diode D3 is turned on to reverse the voltage across the second capacitor C2 and the voltage across the third inductor L3 of the step C to charge the third capacitor C3 and the fourth capacitor C4 in order to make the third capacitor C3 and the fourth capacitor C4 keep powering the load 200 via the inverter circuit 40 according to the positive alternation status or the negative alternation status.

After each of the step A˜step D is executed for one time, it means one operation cycle is finished. Thus, when the AC-AC power source conversion device keeps being in operation, the step A˜step D will be repeatedly executed after the step D until the AC-AC power source conversion device is turned off.

By means of the above design of the AC-AC power source conversion device, in each operation cycle, the voltage across the second capacitor C2 can automatically provide negative potential to turn on the third diode D3 to completely change the circuit structure, which can achieve swift response and low-ripple output voltage; in the meanwhile, the switching of the electronic switch SW can increase the power factor.

Moreover, the design of the fourth diode D4 and the fifth diode D5 can further effectively prevent the backflow of the circuit from influencing the operations of the active power factor correction circuit 20 and the automatic charge pumping circuit 30 respectively, which can make the whole circuit more stable so as to better the power conversion and the ripple voltage suppression effect of the AC-AC power source conversion device. Of course, in practice, the objects of increasing the power conversion efficiency and the ripple voltage suppression effect can be still achieved without the fourth diode D4 and the fifth diode D5.

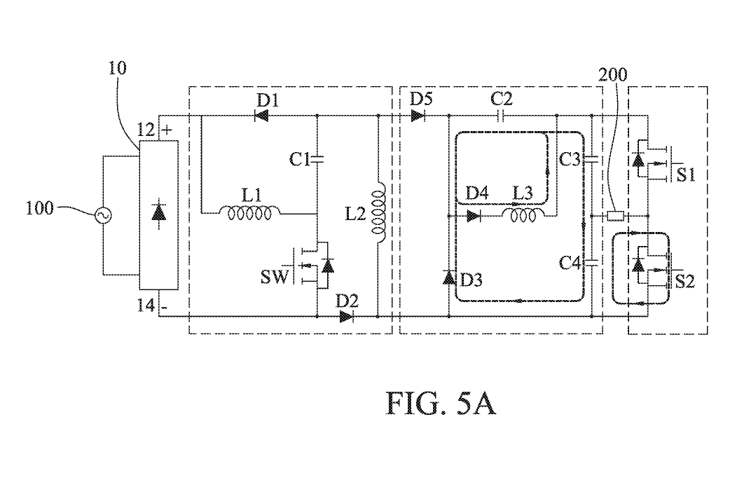

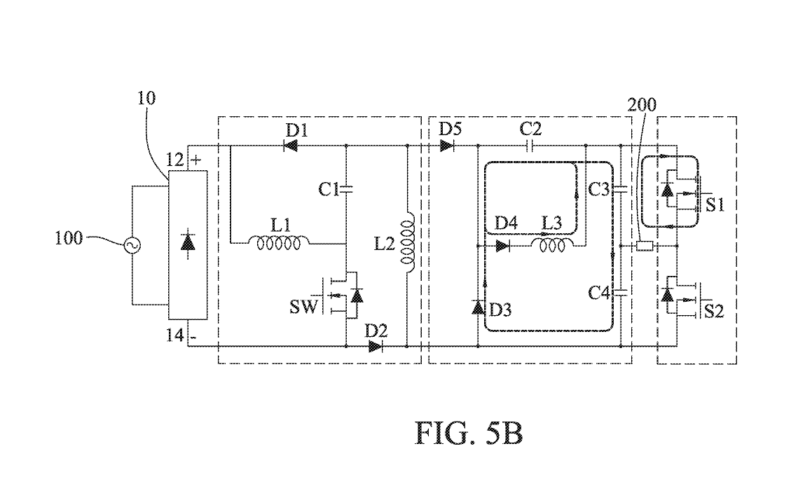

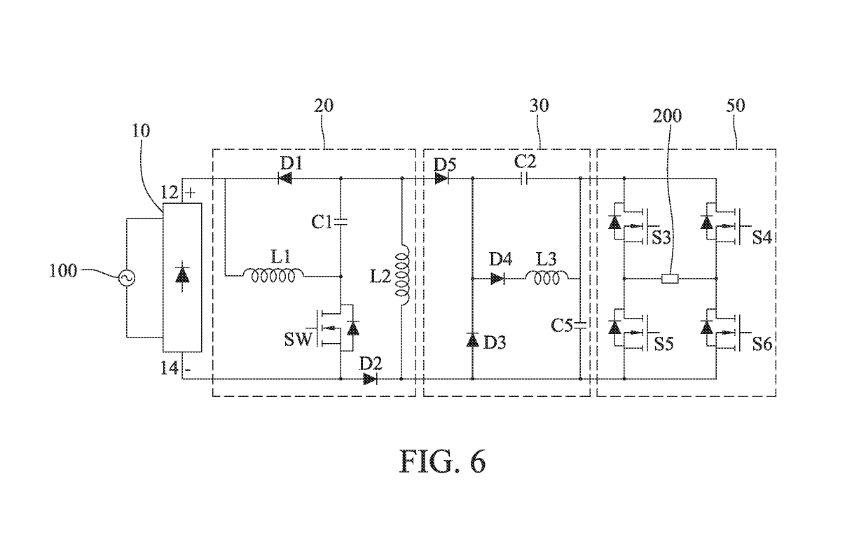

Furthermore, the AC-AC power source conversion device in accordance with the present invention can not only be applied to the half-bridge type inverter circuit 40, but also can be applied to the full-bridge type inverter circuit 50 shown in FIG. 6; the difference between them is that the full-bridge type inverter circuit 50 has the first switch S3˜the fourth switch S6, and the third capacitor C3 and the fourth capacitor C4 serve as the equivalent capacitors; their connection relations are as follows:

The first switch S3 is connected to one end of the third switch S5, and the second switch S4 is connected to one end of the fourth switch S6. Besides, the first switch S3 and the other end of the second switch S4 are connected to the junction of the equivalent capacitor C5, the second capacitor C2 and the third inductor L3, and the third switch S5 and the other end of the fourth switch S6 are connected to the junction of the equivalent capacitor C5, the anode of the third diode D3, the cathode of the second diode D2 and the second inductor L2.

By means of the above structure design, one end of the load 200 can be connected to the junction of the first switch S3 and the third switch S5, and the other end thereof can be connected to the junction of the second switch S4 and the fourth switch S6; the above circuit structure integrated with the aforementioned conversion method can also achieve high power factor, swift response and low-ripple output voltage.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An AC-AC power source conversion device, characterized in converting an electric energy of an AC power source and outputting the electric energy to a load, the AC-AC power source conversion device comprising:
a rectifier circuit, an input side of the rectifier circuit being connected to the AC power source for receiving the electric energy of the AC power source, converting the electric energy into a DC electric energy, and outputting the DC electric energy from an output side of the rectifier circuit; besides, the output side having a positive terminal and a negative terminal;
an active power factor correction circuit, connected to an output side of the rectifier circuit for receiving the DC electric energy of the rectifier circuit, increasing a power factor of the DC electric energy and then outputting the DC electric energy; the active power factor correction circuit comprising:
a first diode, a cathode of the first diode being connected to the positive terminal;
a first capacitor, one end of the first capacitor being connected to an anode of the first diode;
an electronic switch, one end of the electric switch being connected to the other end of the first capacitor, and the other end of the electronic switch being connected to the negative terminal;
a first inductor, one end of the first inductor being connected to a junction of the cathode of the first diode and the positive terminal, and the other end of the first inductor being connected to a junction of the first capacitor and the electronic switch;
a second diode, an anode of the second diode being connected to a junction of the electronic switch and the negative terminal;
a second inductor, one end of the second inductor being connected to a junction of the anode of the first diode and the first capacitor, and the other end of the second inductor being connected to a cathode of the second diode;
an automatic charge pumping circuit, connected to the active power factor correction circuit for receiving the DC electric energy outputted from the active power factor correction circuit, adjusting the DC electric energy and outputting the DC electric energy; the automatic charge pumping circuit comprising:
a third diode, an anode of the third diode being electrically connected to a junction of the cathode of the second diode and the second inductor, and a cathode of the third diode being electrically connected to a junction of the second inductor, the anode of the first diode and the first capacitor;
a second capacitor, one end of the second capacitor being connected to the cathode of the third diode;
a third inductor, one end of the third inductor being connected to the other end of the first capacitor, and the other end of the third inductor being electrically connected to a junction of the cathode of the third diode and the second capacitor;
an equivalent capacitor, one end of the equivalent capacitor being connected to a junction of the second capacitor and the third inductor, and the other end of the equivalent capacitor being connected to a junction of the anode of the third diode, the cathode of the second diode and the second inductor;
an inverter circuit, electrically connected to the equivalent capacitor of the automatic charge pumping circuit, and connected to the load for receiving the DC electric energy outputted from the automatic charge pumping circuit, and converting the DC electric energy into an AC electric energy with a predetermined frequency, and then outputting the AC electric energy with the predetermined frequency to the load.

2. The AC-AC power source conversion device of claim 1, characterized in that the equivalent capacitor is composed of a third capacitor and a fourth capacitor, and the third capacitor is connected to one end of the fourth capacitor; the inverter circuit comprises a first switch and a second switch, and the first switch is connected to one end of the second switch; besides, the third capacitor and the other end of the first switch are connected to the junction of the second capacitor and the third inductor, and the fourth capacitor and the other end of the second switch are connected to the junction of the anode of the third diode, the cathode of the second diode and the second inductor; moreover, one end of the load is connected to a junction of the third capacitor and the fourth capacitor, and the other end of the load is connected to a junction of the first switch and the second switch.

3. The AC-AC power source conversion device of claim 1, characterized in that the inverter circuit comprises a first switch, a second switch, a third switch and a fourth switch; the first switch is connected to one end of the third switch, and the second switch is connected to one end of the fourth switch; besides, the other end of the first switch and the other end of the second switch are connected to a junction of the equivalent capacitor, the second capacitor and the third inductor, and the other end of the third switch and the other end of the fourth switch are connected to a junction of the equivalent capacitor, the anode of the third diode, the cathode of the second diode and the second inductor; moreover, one end of the load is connected to a junction of the first switch and the third switch, and the other end of the load is connected to a junction of the second switch and the fourth switch.

4. The AC-AC power source conversion device of claim 1, characterized in that the automatic charge pumping circuit further comprises a fourth diode; one end of the fourth diode is connected to the junction of the cathode of the third diode and the second capacitor, and the other end of the fourth diode is connected to the third inductor, whereby the third inductor is electrically connected to the junction of the cathode of the third diode and the second capacitor via the fourth diode.

5. The AC-AC power source conversion device of claim 4, characterized in that an anode of the fourth diode is connected to the junction of the cathode of the third diode and the second capacitor, and a cathode of the fourth diode is connected to the third inductor.

6. The AC-AC power source conversion device of claim 1, characterized in that the automatic charge pumping circuit further comprises a fifth diode; one end of the fifth diode is connected to the junction of the second inductor, the anode of the first diode and the first capacitor, and the other end of the fifth diode is connected to the junction of the cathode of the third diode and the second capacitor, whereby the cathode of the third diode and the second capacitor are electrically connected to the junction of the second inductor, the anode of the first diode and the first capacitor via the fifth diode.

7. The AC-AC power source conversion device of claim 6, characterized in that an anode of the fifth diode is connected to the junction of the second inductor, the anode of the first diode and the first capacitor, and a cathode of the fifth diode is connected to the junction of the cathode of the third diode and the second capacitor.

8. A power conversion method of the AC-AC power source conversion device of claim 1, characterized in comprising the following steps:
A. turning on the electronic switch to charge the first inductor by the DC electric energy outputted from the rectifier circuit, and charging the second inductor by the first capacitor, and charging the equivalent capacitor by the second capacitor and the third inductor to make the equivalent capacitor power the load via the inverter circuit;
B. turning off the electronic switch to stop the DC electric energy outputted from the rectifier circuit to charge the first capacitor by the first inductor, and change the third inductor, the second capacitor and the equivalent capacitor by the second inductor to make the equivalent capacitor keep powering the load via the inverter circuit;
C. stopping the second inductor from charging the third inductor, the second capacitor and the equivalent capacitor to make the third inductor charge the second capacitor so as to reverse a voltage across the second capacitor and make the equivalent capacitor keep powering the load via the inverter circuit;
D. turning on the third diode to reverse the voltage across the second capacitor and a voltage across the third inductor, and charging the equivalent capacitor to make the equivalent capacitor keep powering the load via the inverter circuit.

9. The power conversion method of claim 8, characterized in further comprising a step after the step D, and the step being to repeat executing the step A to the step D.

10. The power conversion method of claim 8, characterized in that after the step B, the first inductor stops charging the first capacitor to turn off the first diode.

11. The power conversion method of claim 8, characterized in that during the step B, the second inductor charges the equivalent capacitor via a resonant circuit formed by the second capacitor and the third inductor.

12. The power conversion method of claim 11, characterized in that after the second capacitor and the third inductor form the resonant circuit in the step C, the third inductor charges the second capacitor to reverse a polarity of the voltage across the second capacitor; then, when the voltage across the third inductor is higher than a voltage across the equivalent capacitor, the third diode is turned on, and then the method proceeds to the step D.
